(19) United States
(12) Patent Application Publication
(10) Pub. No.: US 2012/0329931 A1
(43) Pub. Date: Dec. 27, 2012

(54) METHOD FOR PRODUCING AQUEOUS PIGMENT DISPERSION FOR INK JET RECORDING, AND AQUEOUS INK FOR INK JET RECORDING

(75) Inventors: Hiroyuki Buei, Kitamoto-shi (JP); Yoshinosuke Shimamura, Ageo-shi (JP); Shinichi Okada, Kitaadachi-gun (JP); Kenji Nasu, Akashi-shi (JP); Takashi Yoshinari, Kakogawa-shi (JP)

(73) Assignee: DIC CORPORATION, Tokyo (JP)

(21) Appl. No.: 13/441,284

(22) Filed: Apr. 6, 2012

(30) Foreign Application Priority Data
Apr. 6, 2011 (JP) 2011-084691
Apr. 6, 2011 (JP) 2011-084692

(51) Int. Cl. C09D 11/10

(52) U.S. Cl. 524/401

(57) ABSTRACT

A method for producing an aqueous pigment dispersion for ink jet recording that contains only a few coarse particles and has excellent ejection stability, and an aqueous ink for ink jet recording. A method for producing an aqueous pigment dispersion for ink jet recording according to the present invention includes a kneading process for kneading a mixture of a pigment, a resin having an anionic group, and an alkali metal hydroxide to produce a pigment dispersion having a solid content of 50% by mass or more, and a mixing process for mixing and agitating the pigment dispersion in an aqueous medium.

### TECHNICAL FIELD

The present invention relates to a method for producing an aqueous pigment dispersion for ink jet recording, and an aqueous ink for ink jet recording.

### BACKGROUND ART

Aqueous pigment inks for ink jet recording that contain a pigment dispersed in an aqueous medium, a resin having an anionic group, and a basic compound have been proposed as ink jet recording inks that can produce recorded images having high water resistance and light fastness on recording materials.

Since pigments themselves are insoluble in ink solvents (such as water and hydrophilic organic solvents), pigments must be finely divided and dispersed. However, coarse particles that cannot be finely divided and remain in an ink solvent or coarse particles that are formed by aggregation as a result of destabilization associated with particle size reduction may cause clogging in an ink flow channel (orifice) of an ink jet printer head and consequently ink ejection failure.

In recent years, the application of an ink jet recording method has rapidly spread not only in offices but also in the field of various traditional printing industries. Thus, high-speed printing and long-term ejection stability has become important. Thus, the demand for ink jet inks that cause no clogging and can be stably ejected has sharply increased.

Methods for removing coarse particles from liquid after dispersion by a physical method, such as filtration or centrifugation, are proposed (Patent Literatures 1 and 2) as means for solving these problems but do not entirely satisfy the recent demands described above.

Coarse particles are preferably reduced before these downstream processes following dispersion rather than by the downstream processes in terms of production efficiency and production yield. The applicants proposed a method for producing an aqueous pigment dispersion for ink jet recording, which involves a kneading process for kneading a mixture of a pigment, a resin, a basic compound, and a wetting agent to produce a colored kneaded product (Patent Literatures 3 and 4). In the kneading process, the pigment is crushed into fine particles, and simultaneously the surface of crushed pigments is coated with the resin. Thus, this method is effective in reducing coarse particles.

However, even these production methods do not entirely satisfy the recent demands for fewer coarse particles.

In order to improve pigment dispersion, a constituent having a long-chain alkyl group is added to a dispersed resin so as to improve the adsorption of a hydrophobic moiety on a pigment (Patent Literatures 5, 6, and 7).

### CITATION LIST

### Patent Literature

PTL 1 Japanese Unexamined Patent Application Publication No. 2008-222980
PTL 2 Japanese Unexamined Patent Application Publication No. 2009-067911
PTL] Japanese Unexamined Patent Application Publication No. 2003-226832
PTL 4 Japanese Unexamined Patent Application Publication No. 2005-048014
PTL 5 Japanese Unexamined Patent Application Publication No. 9-100428
PTL 6 Japanese Unexamined Patent Application Publication No. 10-158562
PTL 7 Japanese Unexamined Patent Application Publication No. 2000-265083

### SUMMARY OF INVENTION

### Technical Problem

However, even these methods could not effectively reduce coarse particles, although the methods can improve pigment dispersion.

It is an object of the present invention to provide a method for producing an aqueous pigment dispersion for ink jet recording that contains only a few coarse particles and has excellent ejection stability, and an aqueous ink for ink jet recording.

### Solution to Problem

The present inventors completed the present invention by finding that, in an aqueous ink for ink jet recording that contains a pigment, a resin, and a basic compound, a pigment dispersion that contains a resin produced by copolymerization of a particular compound is effective in maintaining a certain pigment concentration and ensuring excellent long-term storage stability and ejection stability.

(1) A method for producing an aqueous pigment dispersion for ink jet recording according to the present invention includes a kneading process for kneading a mixture of a pigment, a resin having an anionic group, and an alkali metal hydroxide to produce a pigment dispersion having a solid content of 50% by mass or more, and a mixing process for mixing and agitating the pigment dispersion in an aqueous medium. The resin having an anionic group is produced by copolymerization of a composition that contains
(a) a monomer having the following general formula (1)

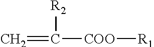

(wherein R₁ denotes a linear or branched alkyl group having 8 to 20 carbon atoms, and R₂ denotes a hydrogen atom or a methyl group)
or the following general formula (2),

HOOC—HC═CH—COO—R₃ (2)
(wherein R₃ denotes a linear or branched alkyl group having 8 to 20 carbon atoms)
(b) a styrene monomer, and
(c) a monomer having an α,β-ethylenically unsaturated bond and an anionic group. When the (a) component is a monomer having the general formula (2), the (c) component is a monomer not having the general formula (2).

The (a) component constitutes 5% by mass or more, and the (b) component constitutes 30% by mass or more, of the total amount of all the monomers of the composition. The resin has an acid value in the range of 50 to 300 mgKOH/g and a mass-average molecular weight in the range of 5000 to 30000.

(2) In a method for producing an aqueous pigment dispersion for ink jet recording according to the present invention, the mixture in the kneading process is preferably prepared by mixing the alkali metal hydroxide, the resin having an anionic group, and the other component(s) in one batch.

(3) In a method for producing an aqueous pigment dispersion for ink jet recording according to the present invention, the mixture in the kneading process and the pigment dispersion produced in the kneading process preferably have a solid content in the range of 50% to 80% by mass.

(4) In a method for producing an aqueous pigment dispersion for ink jet recording according to the present invention, the mass ratio of the resin having an anionic group to the pigment in the pigment dispersion is preferably in the range of 1/10 to 2/1.

(5) An aqueous ink for ink jet recording according to the present invention contains an aqueous pigment dispersion for ink jet recording produced by the method for producing an aqueous pigment dispersion for ink jet recording.

### ADVANTAGEOUS EFFECTS OF INVENTION

A method for producing an aqueous pigment dispersion for ink jet recording according to the present invention allows the production of an aqueous pigment dispersion for ink jet recording that contains only a few coarse particles and has excellent ejection stability. An aqueous ink for ink jet recording according to the present invention that contains the aqueous pigment dispersion for ink jet recording has long-term storage stability and ejection stability as well as excellent light fastness and water resistance as a pigment ink.

### DESCRIPTION OF EMBODIMENTS

The present invention will be further illustrated with embodiments below.

### <<Method for Producing Aqueous Pigment Dispersion for Ink Jet Recording>>

A method for producing an aqueous pigment dispersion for ink jet recording according to the present invention includes a kneading process for kneading a mixture of a pigment, a resin having an anionic group, and an alkali metal hydroxide to produce a pigment dispersion having a solid content of 50% by mass or more, and a mixing process for mixing and agitating the pigment dispersion in an aqueous medium.

In the present specification, in a kneading process for producing a pigment dispersion having a solid content of 50% by mass or more, a material before kneading is referred to as a mixture, and a material during kneading or after kneading is referred to as a kneaded product.

### Resin Having Anionic Group

The resin having an anionic group is produced by copolymerization of a composition that contains
(a) a monomer having the following general formula (1)

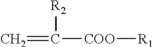

(wherein R₁ denotes a linear or branched alkyl group having 8 to 20 carbon atoms, and R₂ denotes a hydrogen atom or a methyl group)
or the following general formula (2),

HOOC—HC═CH—COO—R₃ (2)
(wherein R₃ denotes a linear or branched alkyl group having 8 to 20 carbon atoms)
(b) a styrene monomer, and
(c) a monomer having an α,β-ethylenically unsaturated bond and an anionic group. When the (a) component is a monomer having the general formula (2), the (c) component is a monomer not having the general formula (2).

Examples of the monomer composed of a compound having the general formula (1) of the (a) component include dodecyl (meth)acrylate, tridecyl (meth)acrylate, tetradecyl (meth)acrylate, hexadecyl (meth)acrylate, octadecyl (meth)acrylate, and icosyl (meth)acrylate. These monomers may be used alone or in combination.

In the general formula (1), the number of carbon atoms of R₁ is in the range of 8 to 20, preferably 12 to 20.

Examples of the monomer composed of a compound having the general formula (2) of the (a) component include monooctyl maleate, mono-2-ethylhexyl maleate, monolauryl maleate, monomyristyl maleate, monocetyl maleate, monostearyl maleate, and monoeicosyl maleate.

A monomer having the general formula (2) can be produced by a reaction between maleic acid anhydride and an alcohol having 8 to 20 carbon atoms in the absence or presence of solvent.

In the general formula (2), the number of carbon atoms of R₃ is in the range of 8 to 20, preferably 12 to 20.

The (a) component having the general formula (1) or (2) constitutes 5% by mass or more, preferably 5% to 40% by mass, more preferably 8% to 40% by mass, of the total amount of all the monomers of the composition. When the (a) component constitutes 5% by mass or more, the resin can have excellent dispersion stability.

When the (a) component constitutes 40% by mass or less, it is easy to maintain a proper hydrophilic and hydrophobic balance in the resin having an anionic group, and the number of coarse particles is effectively reduced.

Since R₁ of the general formula (1) is a long-chain alkyl group, the (a) component is resistant to degradation caused by strong alkalis. Thus, the resin containing the (a) component having the general formula (1) has long-term stability even in the preparation of an aqueous pigment dispersion using an alkali metal hydroxide.

Since R₃ of the general formula (2) is a long-chain alkyl group, the (a) component is resistant to degradation caused by strong alkalis. Thus, the resin containing the (a) component having the general formula (2) has long-term stability even in the preparation of an aqueous pigment dispersion using an alkali metal hydroxide.

Examples of the styrene monomer of the (b) component include styrene, α-methylstyrene, divinylbenzene, 4-methylstyrene, 4-t-butylstyrene, 4-n-octylstyrene, sodium styrenesulfonate, 4-vinylbenzoic acid, 4-aminostyrene, 4-methoxystyrene, 4-nitrostyrene, and stilbene, and styrene is preferred. These may be used alone or in combination.

In terms of dispersion stability and long-term storage stability, the (b) component constitutes 30% by mass or more, preferably 30% to 80% by mass, more preferably 50% to 80% by mass, of all the monomers of the composition.

When the (b) component constitutes 30% by mass or more of the total amount of all the monomers of the composition, the resin having an anionic group becomes more hydrophobic and more strongly covers a pigment in an aqueous medium, thus forming stable particles. Thus, an aqueous ink for ink jet recording resulting from an aqueous pigment dispersion for ink jet recording produced using the resin having an anionic group also has rare occurrence of nozzle clogging. Printing on plain paper with such an aqueous ink for ink jet recording can produce images having high water resistance, high density, and excellent coloring.

When the (b) component constitutes 80% by mass or less, it is easy to maintain a proper hydrophilic and hydrophobic balance in the resin having an anionic group.

Examples of the monomer having an α,β-ethylenically unsaturated bond and an anionic group of the (c) component include monomers having a carboxy group, such as acrylic acid, methacrylic acid, itaconic acid, and (anhydrous) maleic acid, and monoesters thereof. These may be used alone or in combination.

When the (a) component is a component having the general formula (2), the (c) component is a monomer other than the component having the general formula (2) among the monomers having an α,β-ethylenically unsaturated bond and an anionic group.

The (c) component preferably constitutes 5% to 50% by mass of the total amount of all the monomers of the composition. In particular, when the (a) component is a component having the general formula (1), the (c) component more preferably constitutes 8% to 40% by mass of the total amount of all the monomers of the composition. When the (a) component is a component having the general formula (2), the (c) component more preferably constitutes 5% to 40% by mass, still more preferably 5% to 30% by mass.

As described above, the resin having an anionic group is produced by copolymerization of a composition that contains the (a) component, the (b) component, which is a hydrophobic monomer component, and the (c) component having an anionic group. Thus, the resin has excellent dispersion stability and long-term storage stability.

The resin having an anionic group preferably forms a stable coat on a pigment surface in an aqueous medium and preferably has stable water dispersibility due to a neutralized anionic group. In terms of long-term storage stability, the resin has an acid value in the range of 50 to 300 mg potassium hydroxide (KOH)/g, preferably 80 to 200 mgKOH/g, more preferably 100 to 200 mgKOH/g.

The acid value refers to KOH milligram (mg) required to neutralize 1 g of resin and is expressed in mgKOH/g.

An acid value of less than 50 mgKOH/g may result in low hydrophilicity and poor dispersion stability of the pigment. On the other hand, an acid value of more than 300 mgKOH/g may result in low water resistance of images printed with the ink composition.

The resin having an anionic group has a mass-average molecular weight in the range of 5000 to 30000, more preferably 5000 to 20000, particularly preferably 5000 to 15000. The reason for 5000 or more is that a lower molecular weight tends to initially have higher dispersibility but have poorer long-term storage stability. A mass-average molecular weight of more than 30000 tends to result in a higher viscosity of the aqueous pigment dispersion, poorer dispersibility and solubility of the resin, and poorer ejection stability of an ink jet recording ink, particularly a thermal ink jet recording ink.

The resin having an anionic group for use in the present invention can be produced by mixing the (a) component, the (b) component, and the (c) component in an organic solvent in an atmosphere of inert gas, such as nitrogen, adding a polymerization initiator, performing copolymerization at a temperature in the range of 100° C. to 200° C. for 1 to 10 hours, and removing the solvent.

The organic solvent may be, but is not limited to, an alcohol, such as methanol, ethanol, or i-propanol; a ketone, such as acetone or methyl ethyl ketone; an ether, such as tetrahydrofuran or diethyl ether; an ethylene glycol monoalkyl ether or an acetate thereof; a propylene glycol monoalkyl ether or an acetate thereof; a polar organic solvent, such as a diethylene glycol monoalkyl ether; or a nonpolar solvent, such as toluene or xylene. These solvents may be used alone or in combination. Among these, industrially inexpensive xylene, toluene, or a propylene glycol monomethyl ether acetate can preferably be used.

Examples of the polymerization initiator include, but are not limited to, azo polymerization initiators, such as 2,2′-azobis(isobutyronitrile), 2,2′-azobis(2-methylbutyronitrile), 2,2′-azobis(4-methoxy-2,4-dimethylvaleronitrile), 2,2′-azobis(2,4-dimethylvaleronitrile), dimethyl 2,2′-azobis(isobutyrate), and 4,4′-azobis(4-cyanovaleric acid); and organic peroxide polymerization initiators, such as benzoyl peroxide, di-t-butyl peroxide, t-butylperoxy-2-ethylhexanoate, t-butylperoxymaleic acid, t-butylperoxyisopropyl monocarbonate, t-hexylperoxybenzoate, and t-butylperoxybenzoate. These initiators may be used alone or in combination.

A method for producing an aqueous pigment dispersion for ink jet recording according to the present invention includes a kneading process for kneading a mixture of a pigment, a resin having an anionic group, and an alkali metal hydroxide to produce a pigment dispersion having a solid content of 50% by mass or more.

In the kneading process, the resin having an anionic group is preferably powdery or granular. A powdery or granular resin, together with a pigment, experiences strong shear force. The pigment is therefore crushed while the resin having an anionic group is swollen or dissolved by neutralization with an alkali metal hydroxide. Thus, the crushed pigment is rapidly coated with the resin, and kneading proceeds efficiently and satisfactorily.

### Pigment

The pigment in an aqueous pigment dispersion for ink jet recording according to the present invention may be a commercial product without modification.

The pigment may be an inorganic pigment, such as carbon black, an azo pigment, a phthalocyanine pigment, an anthraquinone pigment, a quinacridone pigment, a metal complex pigment, a dioxazine pigment, an indigo pigment, a thioindigo pigment, a perylene pigment, an isoindolinone pigment, an aniline black pigment, an azomethine pigment, or an organic pigment, such as a rhodamine B lake pigment.

In general, when an aqueous pigment dispersion is diluted to produce an ink composition having a certain pigment concentration, it is advantageous in terms of production efficiency to maximize the pigment concentration of the aqueous pigment dispersion because this can increase the production of the ink composition.

However, a higher pigment concentration results in reduced storage stability of the aqueous pigment dispersion. Thus, the pigment concentration of the aqueous pigment dispersion may practically be determined with pigment dispersion stability taken into account and is preferably in the range of 5% to 50% by mass, more preferably 5% to 40% by mass, particularly preferably 10% to 30% by mass.

Regarding the mass ratio of resin to pigment (R/P=mass ratio of resin/pigment), the amount of resin necessary to stably cover the pigment surface is sufficient, and the presence of a resin in excess of this amount is unfavorable. In the production of an aqueous pigment dispersion or an ink composition, the presence of an excessive amount of resin results in an increased amount of free resin, which is not adsorbed on the pigment. In particular, when the ink composition is used as an ink jet recording ink composition, the resin is likely to adhere to an ink nozzle and cause ink ejection failure. In particular, a thermal jet printer is at increased risk of causing ejection failure.

Thus, an aqueous pigment dispersion according to the present invention preferably has a resin/pigment mass ratio in the range of 1/10 to 2/1, more preferably 1/10 to 1/1, particularly preferably 1/10 to 1/2. An excessively high resin/pigment mass ratio tends to cause the problem described above. An excessively low resin/pigment mass ratio may result in insufficient coating of the pigment with the resin and poor dispersion stability and long-term storage stability.

### Alkali Metal Hydroxide

The alkali metal hydroxide for use in a method for producing an aqueous pigment dispersion for ink jet recording according to the present invention is to neutralize an anionic group of the resin having the anionic group and may be a known alkali metal hydroxide.

The alkali metal hydroxide is preferably sodium hydroxide or potassium hydroxide because of their high thermal stability and no odor, more preferably potassium hydroxide because of its stronger basicity.

The alkali metal hydroxide is generally in the form of an approximately 20% to 50% by mass aqueous solution so as to improve miscibility.

In a method for producing an aqueous pigment dispersion for ink jet recording according to the present invention, the resin having an anionic group is neutralized and swollen or dissolved with an alkali metal hydroxide and is kneaded together with a pigment. This allows a kneaded product to be further kneaded while the resin having an anionic group is neutralized with the alkali metal hydroxide.

In general, the amount of alkali metal hydroxide is such that the neutralization rate of the anionic group of the resin for aqueous pigment dispersion is preferably 50% or more and 200% or less, more preferably 80% or more and 120% or less.

At a neutralization rate within these ranges, it is possible to improve the dispersion rate in the aqueous medium and efficiently maintain dispersion stability and long-term storage stability. The neutralization rate is calculated by the following equation.

Neutralization rate (%)=([mass of alkali metal hydroxide (g)×56.1×1000]/[acid value of resin×equivalent of alkali metal hydroxide×mass of resin (g)])×100

The alkali metal hydroxide and the resin having an anionic group are preferably mixed with all the other components of the mixture in one batch before kneading. The mixture may be produced by a plurality of processes by mixing the resin having an anionic group, water, and the alkali metal hydroxide to prepare an aqueous resin solution in advance and adding the aqueous resin solution to the other component(s), such as a pigment. However, it is preferable to mix the alkali metal hydroxide and the resin having an anionic group with the other component(s) in one batch to prepare a mixture for kneading because this allows the resin to be efficiently adsorbed on the pigment surface.

### Wetting Agent

In the production of a pigment dispersion, kneading is preferably performed in the presence of some solvent. The absence of solvent may result in insufficient kneading, insufficient wetting of the pigment surface, and inadequate coating with a resin.

A wetting agent in a pigment dispersion can dissolve, partly dissolve, or swell the resin and thereby allows a uniform resin film to be formed on the surface of pigment particles.

This can further improve the dispersion stability of an aqueous pigment dispersion and an ink composition.

In the present invention, use of an aqueous solution of an alkali metal hydroxide may obviate the necessity of adding a wetting agent because the aqueous solution of an alkali metal hydroxide can serve as a solvent.

The wetting agent may be any known wetting agent.

Examples of the wetting agent include glycols, such as ethylene glycol, diethylene glycol, triethylene glycol, tetraethylene glycol, propylene glycol, poly(ethylene glycol), and poly(propylene glycol); diols, such as butanediol, pentanediol, hexanediol, and homologous diols; glycol esters, such as propylene glycol laurate; glycol ethers, such as diethylene glycol monoethyl ether, diethylene glycol monobutyl ether, diethylene glycol monohexyl ether, propylene glycol ether, dipropylene glycol ether, and cellosolve containing triethylene glycol ether; alcohols, such as methanol, ethanol, isopropyl alcohol, 1-propanol, 2-propanol, 1-butanol, 2-butanol, pentanol, and homologous alcohols; sulfolane; lactones, such as 7-butyrolactone; lactams, such as N-(2-hydroxyethyl)pyrrolidone; glycerin and glycerin derivatives, such as polyoxyalkylene adducts of glycerin; and other various solvents known as water-soluble organic solvents.

These wetting agents may be used alone or in combination. The wetting agent is selected according to the type of resin used and preferably the resin has some solubility in the wetting agent. The amount of wetting agent depends on the solubility of the resin.

Among others, polyhydric alcohols that are liquid at normal temperature and have a high boiling point, low volatility, and high surface tension are preferred because the polyhydric alcohols also serve as wetting agents and anti-drying agents in an aqueous pigment dispersion or an ink composition. Glycols, such as diethylene glycol and triethylene glycol, are particularly preferred. Glycols are generally present in ink compositions and may be present in end products without problems. In particular, in a production method according to the present invention, kneading in the presence of an alkali metal hydroxide obviates the necessity of a water-soluble organic solvent particularly having high solvent power for a resin.

Depending on the type of resin used, the wetting agent preferably constitutes 10% to 50% by mass, more preferably 20% to 40% by mass, of a mixture to be kneaded.

The amount of wetting agent is preferably in the range of approximately 1/2 to five times, more preferably approximately one to four times, the amount of resin. When the amount of wetting agent is less than 1/2 of the amount of resin, it may be impossible to dissolve, partly dissolve, or swell the resin, and this may result in poor dispersion stability of the pigment.

On the other hand, when the amount of wetting agent is more than five times the amount of resin, this may result in a reduced viscosity of a mixture for kneading, inefficient kneading, poor pigment dispersion, and poor image quality, such as ejection failure, in an ink composition.

In the presence of a component serving as a solvent derived from an aqueous solution of an alkali metal hydroxide, as described above, the amount of wetting agent is preferably determined with such a component taken into account.

The mass ratio of the wetting agent to the pigment is preferably 1/5 or more, more preferably in the range of 1/3 to 1. This allows the kneading process to proceed while the resin is continuously in a partially dissolved or swollen state, allowing the pigment surface to be adequately coated with the resin. When the mass ratio of the wetting agent to the pigment is less than 1/5, it may be impossible to sufficiently wet the pigment surface in the early stages of kneading or dissolve, partly dissolve, or swell the resin, and the wetting agent may have insignificant effects.

### Other Resins

A resin other than the resin having an anionic group may be used without losing the advantages of the present invention. Examples of such a resin include acrylic resins, amino resins, urethane resins, epoxy resins, urea resins, vinyl resins, and polyester resins, other than the resin having an anionic group.

In a method for producing an aqueous pigment dispersion for ink jet recording according to the present invention, kneading is preferably performed while the solid content of each of the mixture and the pigment dispersion in the kneading process is maintained in the range of 50% to 80% by mass.

When kneading is performed while such a solid content is maintained, the resin and the pigment are kneaded with strong shear force from the start to the end of kneading, the pigment is crushed into a fine powder having a reduced particle size, and the pigment surface is effectively coated with the resin.

This can significantly improve the dispersion stability and the long-term storage stability of the ink composition. A solid content of 50% by mass or more results in an increased viscosity of the mixture, which allows high-shear kneading and efficient crushing of the pigment, preventing the aqueous pigment dispersion from being contaminated with coarse particles.

A solid content of more than 80% by mass may result in an excessively hard mixture, which makes kneading difficult and pigment dispersion insufficient. Furthermore, it may be difficult to disperse a kneaded product in an aqueous medium after kneading. The solid content may be controlled with water as well as the wetting agent.

After kneading at such a solid content, the liquid components, such as the wetting agent, constitute at least 20% by mass of the kneaded product. Thus, after kneading, only the addition of an aqueous medium and agitation allow the kneaded product to be dispersed in the aqueous medium in a very short time. This improves production efficiency.

In a method for producing an aqueous pigment dispersion for ink jet recording according to the present invention, use of a closed system kneader is preferred because this can prevent the vaporization of an aqueous medium and an increase in solid content during kneading, allowing kneading to proceed in a particular solid content range. This also allows the total amount of aqueous medium and the mass of the solid kneaded product to be substantially unchanged during kneading.

Thus, a certain amount of aqueous medium remains in the kneaded product after kneading, allowing the kneaded product to be easily dispersed in the aqueous medium in the mixing process.

The closed system, as used herein, does not necessarily refer to a completely closed state. There is no need for kneading in a closed state that is completely isolated from the outside air and produces a vacuum.

A closed system kneader in the present invention is a kneader having a closable kneading area, in which the mass of a kneaded product is maintained in the range of 90% by mass or more during kneading.

Such a closed system kneader preferably includes a mixing vessel and a single or multiple impellers. The number of impeller blades is not particularly limited and is preferably two or more so as to perform sufficient kneading.

Unlike two-roll mills or three-roll mills, the state of a raw material at the start of kneading in such a kneader is not particularly limited. A liquid or solid raw material may be directly charged into and mixed in a mixing vessel and may be directly transferred to the kneading process.

Use of such a kneader allows the kneaded product to be directly diluted with and dispersed in an aqueous medium in the same mixing vessel to reduce the viscosity of the kneaded product before transferring the kneaded product to the dispersion process. This can improve production efficiency.

Examples of such a kneader include a Henschel mixer, a pressurized kneader, a Banbury mixer, and a planetary mixer.

A production apparatus for use in a method for producing an aqueous pigment dispersion for ink jet recording according to the present invention is particularly preferably a planetary mixer.

In a method for producing an aqueous pigment dispersion for ink jet recording according to the present invention, the viscosity of a kneaded product widely varies with the kneading state of the kneaded product. A planetary mixer can treat kneaded products having various viscosities from low viscosity to high viscosity, has less dead space in the mixing vessel, and can uniformly knead and agitate a kneaded product in the mixing vessel from material charging to kneading and to dilution of the kneaded product. This can improve production efficiency.

A pigment dispersion produced in the kneading process is then dispersed in an aqueous medium to produce an aqueous pigment dispersion for ink jet recording. The pigment in the pigment dispersion is crushed during kneading of the kneaded product in the kneading process and is coated with the resin having an anionic group neutralized with the alkali metal hydroxide. Thus, because of its high dispersibility in water, the pigment is rapidly dispersed in an aqueous medium in the mixing process. This can improve production efficiency.

### Aqueous Medium

In an aqueous pigment dispersion for ink jet recording according to the present invention, an aqueous medium for dispersing or dissolving the pigment and the resin having an anionic group is water or a mixture of water and a water-soluble organic solvent.

The aqueous medium may be water alone or contain a water-soluble organic solvent that has functions, such as prevention of drying, viscosity control, a wetting agent, and concentration control, in an ink jet recording ink.

Specific examples of such a water-soluble organic solvent include those described for the wetting agent, for example, glycols, such as ethylene glycol, diethylene glycol, triethylene glycol, propylene glycol, dipropylene glycol, tripropylene glycol, and polyoxyalkylene adducts thereof; glycerins, such as glycerin and diglycerin; polyhydric alcohol ethers, such as diethylene glycol diethyl ether and polyoxyalkylene adducts thereof; acetates; thiodiglycol; nitrogen-containing compounds, such as N-methyl-2-pyrrolidone, 1,3-dimethyl-2-imidazolidinone, and dimethylformamide; and dimethyl sulfoxide. These water-soluble organic solvents may function as wetting agents.

Although the production of an aqueous pigment dispersion for ink jet recording according to the present invention does not necessarily require a dispersion process using a dispersing apparatus, a known dispersing apparatus may be used in the dispersion process. Examples of a dispersing apparatus having a dispersing medium include paint shakers, ball mills, attritors, basket mills, sand mills, sand grinders, Dyno-Mill, Dispermat, SC mills, spike mills, and agitator mills. Examples of a dispersing apparatus having no dispersing medium include ultrasonic homogenizers, Nanomiser, dissolvers, dispers, and high-speed impeller dispersing apparatuses. Among these, dispersing apparatuses having a dispersing medium are preferred because of their high dispersing ability. After dispersion, the concentration may be adjusted with an aqueous medium, if necessary.

In the preparation of an aqueous pigment dispersion, various known additive agents, such as a basic compound, may be added as required.

The addition of a basic compound is preferred because this improves dispersion stability.

An aqueous pigment dispersion for ink jet recording produced by a method for producing an aqueous pigment dispersion for ink jet recording according to the present invention contains only a few coarse particles and has excellent storage stability. The reason for such effects is not clear but is assumed as described below. The resin having an anionic group in an aqueous pigment dispersion for ink jet recording according to the present invention has a pendent alkyl group having 8 to 20 carbon atoms derived from the (a) component. The pendent alkyl group has high alkali resistance and is rarely degraded even in long-term storage in the presence of an alkali metal hydroxide. Furthermore, the pendent alkyl group has a high affinity for a pigment and a relatively high degree of flexibility in its structure. Thus, the resin having an anionic group can sufficiently cover a pigment with the pendent alkyl group and effectively prevent the reaggregation of pigment particles.

### Aqueous Ink for Ink Jet Recording

An aqueous ink for ink jet recording according to the present invention can be produced by diluting an aqueous pigment dispersion for ink jet recording produced as described above with an aqueous medium. The pigment concentration of the aqueous ink for ink jet recording is preferably in the range of approximately 2% to 10% by mass.

An aqueous medium for diluting an aqueous pigment dispersion for ink jet recording may be water alone or a wetting agent, which can prevent drying and control the viscosity and concentration.

The addition of a water-soluble organic solvent that can permeate a recording medium to the aqueous medium is preferred because the water-soluble organic solvent can impart penetration ability to the aqueous ink for ink jet recording.

The aqueous ink for ink jet recording may further contain known additive agents. Examples of such additive agents include alkaline agents, pH-adjusting agents, surfactants, preservatives, chelating agents, plasticizers, antioxidants, ultraviolet absorbers, and ultraviolet-curable resins.

An aqueous ink for ink jet recording according to the present invention can be suitably used as an aqueous ink jet recording ink containing a pigment. An aqueous ink for ink jet recording according to the present invention may be used for any ink jet method and may be used in printers of known types, such as continuous ejection types (such as a charge control type and a spray type) and on-demand types (such as a piezoelectric type, a thermal type, and an electrostatic attraction type). In particular, an aqueous ink for ink jet recording according to the present invention may be suitably used in thermal ink jet printers and exhibits excellent dispersion stability, storage stability, and very stable ink ejection.

### EXAMPLES

Although the present invention will be further described in the following examples, the present invention is not limited to these examples. Unless otherwise specified, “parts” refers to “parts by mass”, and “%” refers to “% by mass”.

### Measurement of Acid Value of Resin

### (Total Acid Value: Measurement Method Involving Ring Opening of Acid Anhydride)

The acid value of resin was measured as described below.

30 ml of 1,4-dioxane, 10 ml of pyridine, and 20 mg of 4-dimethylaminopyridine are added to 2.0 g of a resin and are heated to dissolve the resin for 30 minutes to one hour. After 3.5 ml of ion-exchanged water is added to the mixture, the mixture is refluxed for four hours.

After cooling, two to three drops of 1% phenolphthalein in ethanol are added as an indicator, and the mixture is titrated with 0.5 N potassium hydroxide in ethanol. The indicator assumed pale red for 30 seconds at the titration endpoint.

Acid value=V×F×28.05/S
V: the amount of 0.5 N potassium hydroxide in ethanol used (ml)
F: the titer of 0.5 N potassium hydroxide in ethanol
S: the amount of sample (g)

### [Measurement of Molecular Weight of Resin]

The mass-average molecular weight was measured with a GPC apparatus (manufactured by Tosoh Corp., HLC-8120 GPC) using separation columns of two TSK-GEL GMH HR-H columns manufactured by Tosoh Corp. at a column temperature of 40° C., 0.1% by mass tetrahydrofuran as a solvent, and a 0.5 μm filter, at a flow rate of 1 ml/min. The polystyrene equivalent molecular weight was determined using standard polystyrenes.

### A. Synthesis of Resin Containing Component Having General Formula (1)

### Resin Synthesis Example 1

150 parts by mass of a reaction solvent propylene glycol monomethyl ether acetate was charged into a reaction vessel equipped with a thermometer, a Liebig condenser tube, a stirrer, a dropping funnel, and a nitrogen inlet and was refluxed at an internal temperature of 147° C. while the reaction vessel was purged with nitrogen. A mixed solution of 20 parts by mass of stearyl methacrylate, 60 parts by mass of styrene, 20 parts by mass of acrylic acid, and 3.5 parts by mass of di-t-butyl peroxide serving as an initiator was added dropwise to the reaction solvent through the dropping funnel for three hours. The mixture was kept warm for three hours after the dropwise addition and was then heated to 170° C. for distillation at normal pressure. After the internal temperature reached 170° C., unreacted raw materials were evaporated at a reduced pressure of 10 hPa for one hour to yield a resin 1 for aqueous pigment dispersion. The resin 1 had a mass-average molecular weight of 8,300 and an acid value of 147 mgKOH/g.

### Resin Synthesis Examples 2 to 12

Resins 2 to 12 for aqueous pigment dispersion were prepared in the same manner as the resin 1 except that the monomers and mass parts were changed as described in the (a) component, the (b) component, and the (c) component of Table 1. The amounts of reaction solvent and initiator were appropriately changed to control molecular weight. Table 1 shows the physical properties of the resins 2 to 12.

In Table 1, St denotes styrene, AA denotes acrylic acid, and MAA denotes methacrylic acid.

TABLE 1

| Resin | | | | | Molecular |
|---|---|---|---|---|---|
| No. | (a) component | (b) component | (c) component | Acid value | weight |
| 1 | C₁₈ methacrylate 20 parts | St 60 parts | AA 20 parts | 147 | 8,300 |
| 2 | C₁₈ methacrylate 20 parts | St 56 parts | MAA 24 parts | 146 | 7,910 |
| 3 | C₁₈ methacrylate 10 parts | St 70 parts | AA 20 parts | 147 | 8,190 |
| 4 | C₁₂ methacrylate 20 parts | St 60 parts | AA 20 parts | 145 | 8,530 |
| 5 | C₁₂ methacrylate 10 parts | St 70 parts | AA 20 parts | 146 | 8,890 |
| 6 | C₁₈ methacrylate 20 parts | St 60 parts | AA 25 parts | 181 | 8,550 |
| 7 | C₁₈ methacrylate 20 parts | St 69 parts | AA 16 parts | 118 | 8,110 |
| 8 | C₁₈ methacrylate 20 parts | St 60 parts | AA 20 parts | 146 | 12,600 |
| 9 | C₁₈ methacrylate 20 parts | St 60 parts | AA 20 parts | 147 | 5,880 |
| 10 | C₁₈ methacrylate 2 parts | St 78 parts | AA 20 parts | 147 | 8,440 |
| 11 | C₄ methacrylate 20 parts | St 60 parts | AA 20 parts | 145 | 8,630 |
| 12 | None | St 80 parts | AA 20 parts | 148 | 8,010 |

### B. Synthesis of Resin Containing Component Having General Formula (2)

(Synthesis of Monostearyl Maleate Monomer (a-1))

Maleic anhydride/stearyl alcohol=1/1 (molar ratio) were charged into a reaction vessel equipped with a thermometer, a Liebig condenser tube, and a stirrer and were allowed to react at 115° C. for six hours to yield a monostearyl maleate monomer (a-1). Measurement of the infrared absorption spectrum of the monomer (a-1) showed that the absorption of an acid anhydride group (1785 cm⁻¹) disappeared. The monomer (a-1) had an acid value of 152 mgKOH/g.

(Synthesis of Monolauryl Maleate Monomer (a-2))

A monolauryl maleate monomer (a-2) was prepared in the same manner as the monomer (a-1) except that the alcohol was changed to lauryl alcohol. The monomer (a-2) had an acid value of 198 mgKOH/g.

(Synthesis of Mono-n-butyl Maleate Monomer (a-3))

A mono-n-butyl maleate monomer (a-3) was prepared in the same manner as the monomer (a-1) except that the alcohol was changed to n-butanol. The monomer (a-3) had an acid value of 330 mgKOH/g.

### Resin Synthesis Example 13

100 parts by mass of a reaction solvent propylene glycol monomethyl ether acetate was charged into a reaction vessel equipped with a thermometer, a Liebig condenser tube, a stirrer, a dropping funnel, and a nitrogen inlet and was refluxed at an internal temperature of 147° C. while the reaction vessel was purged with nitrogen. A mixed solution of 20 parts by mass of the monostearyl maleate (a-1) prepared as described above, 64.5 parts by mass of styrene, 15.5 parts by mass of acrylic acid, 2.5 parts by mass of an initiator di-t-butyl peroxide, and 20 parts by mass of propylene glycol monomethyl ether acetate was added dropwise to the reaction solvent through the dropping funnel for three hours. The mixture was kept warm for three hours after the dropwise addition and was then heated to 170° C. for distillation at normal pressure. After the internal temperature reached 170° C., unreacted raw materials were evaporated at a reduced pressure of 10 hPa for one hour to yield a resin 13 for aqueous pigment dispersion. The resin 13 had a mass-average molecular weight of 8,100 and an acid value of 148 mgKOH/g.

### Resin Synthesis Examples 14 to 24

Resins 14 to 24 for aqueous pigment dispersion were prepared in the same manner as the resin 13 except that the monomers and mass parts were changed as described in the (a) component, the (b) component, and the (c) component of Table 2. The amounts of reaction solvent and initiator were appropriately changed to control molecular weight. Table 1 shows the physical properties of the resins 13 to 24.

In Table 2, St denotes styrene, AA denotes acrylic acid, and MAA denotes methacrylic acid.

TABLE 2

| Resin | | | | | Molecular |
|---|---|---|---|---|---|
| No. | (a) component | (b) component | (c) component | Acid value | weight |
| 13 | C₁₈ maleic acid monoester 20 parts | St 64.5 parts | AA 15.5 parts | 148 | 8,100 |
| 14 | C₁₈ maleic acid monoester 20 parts | St 62 parts | MAA 18 parts | 151 | 8.05 |
| 15 | C₁₈ maleic acid monoester 10 parts | St 72.5 parts | AA 17.5 parts | 150 | 7,730 |
| 16 | C₁₂ maleic acid monoester 20 parts | St 66 parts | AA 14 parts | 149 | 9,700 |
| 17 | C₁₂ maleic acid monoester 10 parts | St 73.3 parts | AA 16.7 parts | 149 | 7,670 |
| 18 | C₁₈ maleic acid monoester 20 parts | St 61 parts | AA 19 parts | 179 | 8,300 |
| 19 | C₁₈ maleic acid monoester 20 parts | St 70.8 parts | AA 9.2 parts | 100 | 7,920 |
| 20 | C₁₈ maleic acid monoester 20 parts | St 64.5 parts | AA 15.5 parts | 149 | 13,600 |
| 21 | C₁₈ maleic acid monoester 20 parts | St 64.5 parts | AA 15.5 parts | 151 | 6,110 |
| 22 | C₁₈ maleic acid monoester 2 parts | St 78 parts | AA 20 parts | 154 | 8,080 |
| 23 | C4 maleic acid monoester 20 parts | St 70 parts | AA 10 parts | 153 | 7,810 |
| 24 | None | St 79 parts | AA 21 parts | 150 | 8,200 |

### Example 1

### Pigment Dispersion Process with Planetary Mixer

1500 parts by mass of the resin 1 prepared in synthesis example 1, 5000 parts by mass of FASTOGEN BLUE TGR (Pigment Blue 15:3) (manufactured by DIC Corp.), 650 parts by mass of 34% by mass aqueous potassium hydroxide, and 2300 parts by mass of diethylene glycol were charged into a 50-L planetary mixer PLM-V-50V (manufactured by Inoue Manufacturing Co., Ltd.). While the jacket was heated, the mixture was kneaded at a low speed (the number of rotations: 21 rpm, the number of revolutions: 14 rpm) until the temperature of the contents reached 60° C. After the temperature of the contents reached 60° C., kneading was continued at a high speed (the number of rotations: 35 rpm, the number of revolutions: 24 rpm).

15 minutes after the planetary mixer had the maximum load current upon switching to the high speed, the load current of the planetary mixer was decreased and leveled off. Kneading was continued in this state another three hours to yield a kneaded product. 500 parts by mass of ion-exchanged water was added to the kneaded product in the mixing vessel and was continuously kneaded. After ensuring that the kneaded product was homogeneous, another 500 parts by mass of ion-exchanged water was added to the kneaded product and was kneaded until the kneaded product became homogeneous. The viscosity of the kneaded product was then adjusted. In the same manner, 500 parts by mass of ion-exchanged water was repeatedly added to the kneaded product such that the total amount of ion-exchanged water was 4000 parts by mass. While kneading was continued, the amount of ion-exchanged water added at a time was increased to 1000 parts by mass. While ensuring that the kneaded product was homogeneous, as described above, another 4000 parts by mass of ion-exchanged water in total was added to the kneaded product.

1700 parts by mass of diethylene glycol, 14000 parts by mass of ion-exchanged water, and 33 parts by mass of a preservative were then added to the kneaded product and were stirred. The pigment concentration was then adjusted to 15% by mass with ion-exchanged water. The resulting aqueous pigment dispersion was removed from the planetary mixer.

### Centrifugation Process

The aqueous pigment dispersion was continuously centrifuged in a continuous centrifuge (H-6005 manufactured by Kokusan Enshinki Co., Ltd., capacity 2 L) at room temperature at a centrifugal force of 18900 G at a residence time of 12 minutes. After the dispersion was collected, ion-exchanged water was added to the dispersion such that the pigment concentration was 13.5% by mass, yielding an aqueous pigment dispersion for ink jet recording according to Example 1.

### Example 2

An aqueous pigment dispersion for ink jet recording according to Example 2 was prepared in the same manner as in Example 1 except that 2000 parts by mass instead of 1500 parts by mass of the resin 1 and 865 parts by mass instead of 650 parts by mass of 34% by mass aqueous potassium hydroxide were used.

### Examples 3 to 11

Aqueous pigment dispersions for ink jet recording according to Examples 3 to 11 were prepared as described above using the compositions listed in Table 3. In Table 3, PLM denotes a planetary mixer, bead denotes a bead mill, and R/P denotes the mass ratio of resin to pigment.

### Comparative Example 1

### Pigment Dispersion Process with Bead Mill

4000 parts by mass of diethylene glycol, 22000 parts by mass of ion-exchanged water, 1500 parts by mass of the resin 1 prepared in the synthesis example 1, and 415 parts by mass of diethanolamine were charged into a clean 100-L stainless steel container and were dissolved while stirring with a dispersion stirrer having a turbine type impeller.

After 5000 parts by mass of FASTOGEN BLUE TGR (Pigment Blue 15:3) (manufactured by DIC Corp.) was added while stirring, stirring for one hour yielded a slurry.

The slurry was passed through a bead mill (NANO MILL NM-G2L manufactured by Asada Iron Works Co., Ltd.) four times (four passes) under the following conditions to be dispersed. 33 parts by mass of a preservative was added to the slurry and was stirred. The slurry was adjusted to a pigment concentration of 15% by mass with ion-exchanged water to prepare an aqueous pigment dispersion.

### <Dispersion Conditions for Bead Mill>

| | |
|---|---|
| Beads | φ0.3 mm zirconia beads |
| Beads loading | 85% |
| Cooling water temperature | 10° C. |
| Number of rotations | 2660 rpm (disk peripheral speed: 12.5 m/sec) |
| Feed rate | 200 g/min |

### Centrifugation Process

The aqueous pigment dispersion was continuously centrifuged in a continuous centrifuge (H-6005 manufactured by Kokusan Enshinki Co., Ltd., capacity 2 L) at room temperature at a centrifugal force of 18900 G at a residence time of 12 minutes. After the dispersion was collected, ion-exchanged water was added to the dispersion such that the pigment concentration was 13.5% by mass, yielding an aqueous pigment dispersion for ink jet recording according to Comparative Example 1.

### Comparative Example 2

An aqueous pigment dispersion for ink jet recording according to Comparative Example 2 was prepared in the same manner as in Comparative Example 1 except that 415 parts by mass of diethanolamine was replaced by 650 parts by mass of 34% by mass aqueous potassium hydroxide.

### Comparative Examples 3 to 5

Aqueous pigment dispersions for ink jet recording according to Comparative Examples 3 to 5 were prepared in the same manner as in Comparative Example 1 with the compositions listed in Table 3. In Table 3, PLM denotes a planetary mixer, bead denotes a bead mill, and R/P denotes the mass ratio of resin to pigment.

TABLE 3

| | | Acid value | | Dispersion | | | 34% | |
|---|---|---|---|---|---|---|---|---|
| | Resin No. | of resin | R/P | method | Pigment | Resin | KOH | Diethanolamine |
| Example 1 | Resin 1 | 147 | 0.3 | PLM | 5000 | 1500 | 650 | |
| Example 2 | Resin 1 | 147 | 0.4 | PLM | 5000 | 2000 | 865 | |
| Example 3 | Resin 1 | 147 | 0.2 | PLM | 5000 | 1000 | 432 | |
| Example 4 | Resin 2 | 146 | 0.3 | PLM | 5000 | 1500 | 644 | |
| Example 5 | Resin 3 | 147 | 0.3 | PLM | 5000 | 1500 | 650 | |
| Example 6 | Resin 4 | 145 | 0.3 | PLM | 5000 | 1500 | 640 | |
| Example 7 | Resin 5 | 146 | 0.3 | PLM | 5000 | 1500 | 644 | |
| Example 8 | Resin 6 | 181 | 0.3 | PLM | 5000 | 1500 | 799 | |
| Example 9 | Resin 7 | 118 | 0.3 | PLM | 5000 | 1500 | 521 | |
| Example 10 | Resin 8 | 146 | 0.3 | PLM | 5000 | 1500 | 644 | |
| Example 11 | Resin 9 | 147 | 0.3 | PLM | 5000 | 1500 | 649 | |
| Comparative | Resin 1 | 147 | 0.3 | Bead | 5000 | 1500 | | 415 |
| example 1 | | | | | | | | |
| Comparative | Resin 1 | 147 | 0.3 | Bead | 5000 | 1500 | 650 | |
| example 2 | | | | | | | | |
| Comparative | Resin 10 | 147 | 0.3 | PLM | 5000 | 1500 | 650 | |
| example 3 | | | | | | | | |
| Comparative | Resin 11 | 145 | 0.3 | PLM | 5000 | 1500 | 640 | |
| example 4 | | | | | | | | |
| Comparative | Resin 12 | 148 | 0.3 | PLM | 5000 | 1500 | 653 | |
| example 5 | | | | | | | | |

### Example 12

### Pigment Dispersion Process with Planetary Mixer

1500 parts by mass of the resin 13 prepared in synthesis example 13, 5000 parts by mass of FASTOGEN BLUE TGR (Pigment Blue 15:3) (manufactured by DIC Corp.), 655 parts by mass of 34% by mass of aqueous potassium hydroxide, and 2300 parts by mass of diethylene glycol were charged into a 50-L planetary mixer PLM-V-50V (manufactured by Inoue Manufacturing Co., Ltd.). While the jacket was heated, the mixture was kneaded at a low speed (the number of rotations: 21 rpm, the number of revolutions: 14 rpm) until the temperature of the contents reached 60° C. After the temperature of the contents reached 60° C., kneading was continued at a high speed (the number of rotations: 35 rpm, the number of revolutions: 24 rpm).

15 minutes after the planetary mixer had the maximum load current upon switching to the high speed, the load current of the planetary mixer was decreased and leveled off. Kneading was continued in this state another three hours to yield a kneaded product. 500 parts by mass of ion-exchanged water was added to the kneaded product in the mixing vessel and was continuously kneaded. After ensuring that the kneaded product was homogeneous, another 500 parts by mass of ion-exchanged water was added to the kneaded product and was kneaded until the kneaded product became homogeneous. The viscosity of the kneaded product was then adjusted. In the same manner, 500 parts by mass of ion-exchanged water was repeatedly added to the kneaded product such that the total amount of ion-exchanged water was 4000 parts by mass. While kneading was continued, the amount of ion-exchanged water added at a time was increased to 1000 parts by mass. While ensuring that the kneaded product was homogeneous, as described above, another 4000 parts by mass of ion-exchanged water in total was added to the kneaded product.

1700 parts by mass of diethylene glycol, 14000 parts by mass of ion-exchanged water, and 33 parts by mass of a preservative were then added to the kneaded product and were stirred. The pigment concentration was then adjusted to 15% by mass with ion-exchanged water. The resulting aqueous pigment dispersion for ink jet recording was removed from the planetary mixer.

### Centrifugation Process

The aqueous pigment dispersion was continuously centrifuged in a continuous centrifuge (H-6005 manufactured by Kokusan Enshinki Co., Ltd., capacity 2 L) at room temperature at a centrifugal force of 18900 G at a residence time of 12 minutes. After the dispersion was collected, ion-exchanged water was added to the dispersion such that the pigment concentration was 13.5% by mass, yielding an aqueous pigment dispersion for ink jet recording according to Example 12.

### Example 13 to 22

An aqueous pigment dispersion for ink jet recording according to Example 13 was prepared in the same manner as in Example 12 except that 2000 parts by mass instead of 1500 parts by mass of the resin 13 and 870 parts by mass instead of 655 parts by mass of 34% by mass aqueous potassium hydroxide were used. Aqueous pigment dispersions for ink jet recording according to Examples 14 to 22 were prepared as described above using the compositions listed in Table 4.

### Comparative Example 6

### Pigment Dispersion Process with Bead Mill

4000 parts by mass of diethylene glycol, 22000 parts by mass of ion-exchanged water, 1500 parts by mass of the resin 1 prepared in the synthesis example 1, and 655 parts by mass of 34% by mass aqueous potassium hydroxide were charged into a clean 100-L stainless steel container and were dissolved while stirring with a dispersion stirrer having a turbine type impeller.

After 5000 parts by mass of FASTOGEN BLUE TGR (Pigment Blue 15:3) (manufactured by DIC Corp.) was added while stirring, stirring for one hour yielded a slurry.

The slurry was passed through a bead mill (NANO MILL NM-G2L manufactured by Asada Iron Works Co., Ltd.) four times (four passes) under the following conditions to be dispersed. 33 parts by mass of a preservative was added to the slurry and was stirred. The slurry was adjusted to a pigment concentration of 15% by mass with ion-exchanged water to prepare an aqueous pigment dispersion for ink jet recording.

### <Dispersion Conditions for Bead Mill>

| | |
|---|---|
| Beads | φ0.3 mm zirconia beads |
| Beads loading | 85% |
| Cooling water temperature | 10° C. |
| Number of rotations | 2660 rpm (disk peripheral speed: 12.5 m/sec) |
| Feed rate | 200 g/min |

### Centrifugation Process

The aqueous pigment dispersion was continuously centrifuged in a continuous centrifuge (H-6005 manufactured by Kokusan Enshinki Co., Ltd., capacity 2 L) at room temperature at a centrifugal force of 18900 G at a residence time of 12 minutes. After the dispersion was collected, ion-exchanged water was added to the dispersion such that the pigment concentration was 13.5% by mass, yielding an aqueous pigment dispersion for ink jet recording according to Comparative Example 6.

### Comparative Examples 7 to 9

Aqueous pigment dispersions for ink jet recording according to Comparative Examples 7 to 9 were prepared in the same manner as in Example 12 using compositions listed in Table 4. In Table 4, PLM denotes a planetary mixer, bead denotes a bead mill, and R/P denotes the mass ratio of resin to pigment.

TABLE 4

| | | Acid value | | Dispersion | | | 34% | |
|---|---|---|---|---|---|---|---|---|
| | Resin No. | of resin | R/P | method | Pigment | Resin | KOH | Diethanolamine |
| Example 12 | Resin 13 | 148 | 0.3 | PLM | 5000 | 1500 | 655 | |
| Example 13 | Resin 13 | 148 | 0.4 | PLM | 5000 | 2000 | 870 | |
| Example 14 | Resin 13 | 148 | 0.2 | PLM | 5000 | 1000 | 435 | |
| Example 15 | Resin 14 | 151 | 0.3 | PLM | 5000 | 1500 | 666 | |
| Example 16 | Resin 15 | 150 | 0.3 | PLM | 5000 | 1500 | 662 | |
| Example 17 | Resin 16 | 149 | 0.3 | PLM | 5000 | 1500 | 657 | |
| Example 18 | Resin 17 | 149 | 0.3 | PLM | 5000 | 1500 | 657 | |
| Example 19 | Resin 18 | 179 | 0.3 | PLM | 5000 | 1500 | 790 | |
| Example 20 | Resin 19 | 100 | 0.3 | PLM | 5000 | 1500 | 441 | |
| Example 21 | Resin 20 | 149 | 0.3 | PLM | 5000 | 1500 | 657 | |
| Example 22 | Resin 21 | 151 | 0.3 | PLM | 5000 | 1500 | 666 | |
| Comparative | Resin 13 | 148 | 0.3 | Bead | 5000 | 1500 | | 416 |
| example 6 | | | | | | | | |
| Comparative | Resin 22 | 154 | 0.3 | PLM | 5000 | 1500 | 679 | |
| example 7 | | | | | | | | |
| Comparative | Resin 23 | 153 | 0.3 | PLM | 5000 | 1500 | 675 | |
| example 8 | | | | | | | | |
| Comparative | Resin 24 | 150 | 0.3 | PLM | 5000 | 1500 | 662 | |
| example 9 | | | | | | | | |

Tables 5 and 6 show the characteristics of the aqueous pigment dispersions for ink jet recording according to Examples 1 to 22 and Comparative Examples 1 to 9 measured by the following test methods.

### Volume-Average Particle Size

The particle size of the aqueous pigment dispersions for ink jet recording according to the examples and comparative examples was measured with a MICROTRAC UPA150EX particle size analyzer (manufactured by Nikkiso Co., Ltd.) at a cell temperature of 25° C. A sample for particle size measurement was prepared by diluting each of the dispersions with ion-exchanged water to a pigment concentration of 12.5% by mass and then 500-fold with ion-exchanged water.

### Number of Coarse Particles

The number of coarse particles was measured with ACCUSIZER 780 (Particle Sizing Systems, Inc.). A sample for the measurement of the number of coarse particles was prepared by decreasing the pigment concentration with 200- to 10000-fold ion-exchanged water such that the number of counts of coarse particles having a particle size of 0.5 μm or more was in the range of 1000 to 4000 when the sample passed through a detector at 1 ml/s.

The number of coarse particles in 1 ml of an aqueous pigment dispersion for ink jet recording having a pigment concentration of 12.5% by mass was calculated with the dilution ratio taken into account.

### Storage Stability

Storage stability was evaluated with aqueous pigment dispersions according to the examples and comparative examples stored at 60° C. Storage stability was evaluated on the basis of a difference between the initial particle size before the start of the test and the particle size six weeks after the start of the test. The evaluation criteria were as follows:
Double circle: 5% or less,
Circle: more than 5% and 10% or less,
Triangle: more than 10% and 20% or less, and
Cross: more than 20%.

### Ink Jet Ejection Stability

### (Preparation of Test Ink)

5 parts of diethylene glycol, 5 parts by mass of SANNIX GP-600 (manufactured by Sanyo Chemical Industries, Ltd.), 3 parts by mass of glycerin, and 63.9 parts by mass of ion-exchanged water were added to 23.1 parts by mass of each of the aqueous pigment dispersions for ink jet recording for ink jet recording according to the examples and comparative examples and were uniformly stirred to prepare an aqueous ink for ink jet recording having a pigment concentration of 3% by mass.

(Ejection Test): Immediately after Ink Preparation

The aqueous ink for ink jet recording thus prepared was tested with an ink jet printer (PHOTOSMART D5360 manufactured by HP Co.). After a cartridge for black was filled with an ink, a nozzle check pattern was printed at the start of the test. After printing at a print density of 100% in a monochrome mode in a 340-cm² area on one A4 sheet, a nozzle check pattern was printed. The states of the nozzle before and after the test were compared. The evaluation criteria were as follows:
Double circle: no nozzle chipping,
Circle: no increase in nozzle chipping,
Triangle: an increase in nozzle chipping by 1 to 5 points, and
Cross: an increase in nozzle chipping by 6 points or more.

(Ejection Test): After Storage

After the test was performed immediately after ink preparation, the cartridge filled with the test ink was left to stand for four weeks. The printing test performed immediately after the preparation was then performed again.

TABLE 5

| | | | | | Immediately | |
|---|---|---|---|---|---|---|
| | | Before | | | after ink | After |
| | Volume- | centrifugation | After centrifugation | | preparation | storage |
| | average particle | Number of coase | Number of coase | Storage | Ejection | Ejection |
| | size (nm) | particles (×10⁶/ml) | particles (×10⁶/ml) | stability | stability | stability |
| Example 1 | 104 | 10200 | 132 | [symbol] | [symbol] | [symbol] |
| Example 2 | 103 | 10300 | 151 | [symbol] | [symbol] | [symbol] |
| Example 3 | 112 | 13200 | 320 | ◯ | ◯ | ◯ |
| Example 4 | 107 | 12900 | 291 | ◯ | ◯ | ◯ |
| Example 5 | 105 | 11600 | 192 | [symbol] | [symbol] | ◯ |
| Example 6 | 105 | 11100 | 165 | ◯ | [symbol] | [symbol] |
| Example 7 | 108 | 13800 | 232 | ◯ | ◯ | ◯ |
| Example 8 | 104 | 10400 | 159 | [symbol] | [symbol] | [symbol] |
| Example 9 | 111 | 13300 | 369 | ◯ | ◯ | ◯ |
| Example 10 | 109 | 12500 | 254 | ◯ | ◯ | ◯ |
| Example 11 | 106 | 11300 | 235 | ◯ | ◯ | ◯ |
| Comparative | 152 | 32000 | 2640 | Δ | Δ | X |
| example 1 | | | | | | |
| Comparative | 136 | 23000 | 1950 | ◯ | ◯ | X |
| example 2 | | | | | | |
| Comparative | 117 | 28000 | 2210 | ◯ | ◯ | X |
| example 3 | | | | | | |
| Comparative | 182 | 49000 | 7300 | X | X | X |
| example 4 | | | | | | |
| Comparative | 110 | 30000 | 2390 | ◯ | ◯ | X |
| example 5 | | | | | | |

Table 5 shows that the volume-average particle sizes of the aqueous pigment dispersions for ink jet recording according to Examples 1 to 11 are substantially the same as the volume-average particle sizes of the aqueous pigment dispersions for ink jet recording according to Comparative Examples 3 and 5.

However, the number of coarse particles before centrifugation was smaller in the aqueous pigment dispersions for ink jet recording according to Examples 1 to 11 than in the aqueous pigment dispersions for ink jet recording according to Comparative Examples 3 and 5. Even under the same centrifugation conditions, the number of coarse particles after centrifugation was reduced more in Examples 1 to 11 than in Comparative Examples 3 and 5.

In the examples, the aqueous pigment dispersions for ink jet recording according to Examples 1, 2, 5, and 8, which contained a particularly few coarse particles, were shown to have better storage stability.

The aqueous inks for ink jet recording prepared using the aqueous pigment dispersions for ink jet recording according to Examples 1 to 11 were shown to have better ejection stability than the aqueous inks for ink jet recording prepared using the aqueous pigment dispersions for ink jet recording according to Comparative Examples 1 to 5.

In particular, comparing the aqueous pigment dispersions for ink jet recording according to Example 1 and Comparative Example 2, which were different only in the preparation method, the aqueous pigment dispersion for ink jet recording according to Example 1 prepared with a planetary mixer contained much fewer coarse particles after centrifugation than the aqueous pigment dispersion for ink jet recording according to Comparative Example 2 prepared by a bead mill method, indicating that a method with a planetary mixer can effectively reduce the number of coarse particles.

Furthermore, comparing the aqueous pigment dispersions for ink jet recording according to Comparative Examples 1 and 2, which were different in the type of basic compound used, the aqueous pigment dispersion for ink jet recording according to Comparative Example 1, which used diethanolamine, contained more coarse particles and had poorer storage stability and ejection stability than the aqueous pigment dispersion for ink jet recording according to Comparative Example 2, which used potassium hydroxide.

Comparing the aqueous pigment dispersions for ink jet recording according to Example 5 and Comparative Example 3, which were different in the (a) component content, the aqueous pigment dispersion for ink jet recording according to Comparative Example 3, in which the (a) component content was only 2%, contained much more coarse particles and had poorer storage stability and ejection stability than the aqueous pigment dispersion for ink jet recording according to Example 5.

Comparing the aqueous pigment dispersions for ink jet recording according to Example 6 and Comparative Example 4, which were different in the number of carbon atoms of the alkyl methacrylate of the (a) component, the aqueous pigment dispersion for ink jet recording according to Comparative Example 4, which contained a resin prepared using an alkyl methacrylate having, on its side chain, an alkyl group having four carbon atoms, had a markedly larger volume-average particle size, much more coarse particles, and much poorer storage stability and ejection stability than the aqueous pigment dispersion for ink jet recording according to Example 6.

Table 6 shows the characteristics of the aqueous pigment dispersions for ink jet recording according to Examples 12 to 22 and Comparative Examples 6 to 9 measured by the same test methods.

TABLE 6

| | | | | | Immediately | |
|---|---|---|---|---|---|---|
| | | Before | | | after ink | After |
| | Volume- | centrifugation | After centrifugation | | preparation | storage |
| | average particle | Number of coase | Number of coase | Storage | Ejection | Ejection |
| | size (nm) | particles (×10⁶/ml) | particles (×10⁶/ml) | stability | stability | stability |
| Example 12 | 104 | 12700 | 53 | [symbol] | [symbol] | [symbol] |
| Example 13 | 105 | 10600 | 135 | [symbol] | [symbol] | [symbol] |
| Example 14 | 113 | 12200 | 214 | ◯ | ◯ | ◯ |
| Example 15 | 111 | 13200 | 296 | ◯ | ◯ | ◯ |
| Example 16 | 112 | 11500 | 181 | ◯ | [symbol] | ◯ |
| Example 17 | 111 | 11400 | 193 | ◯ | [symbol] | ◯ |
| Example 18 | 113 | 12500 | 268 | ◯ | ◯ | ◯ |
| Example 19 | 107 | 9500 | 102 | [symbol] | [symbol] | [symbol] |
| Example 20 | 122 | 13300 | 212 | ◯ | ◯ | ◯ |
| Example 21 | 114 | 12600 | 182 | ◯ | [symbol] | ◯ |
| Example 22 | 110 | 11200 | 152 | ◯ | [symbol] | ◯ |
| Comparative | 136 | 10800 | 4550 | X | Δ | X |
| example 6 | | | | | | |
| Comparative | 115 | 26000 | 2160 | ◯ | ◯ | X |
| example 7 | | | | | | |
| Comparative | 182 | 28000 | 7500 | X | X | X |
| example 8 | | | | | | |
| Comparative | 110 | 30000 | 2410 | ◯ | ◯ | X |
| example 9 | | | | | | |

Table 6 shows that the volume-average particle sizes of the aqueous pigment dispersions for ink jet recording according to Examples 12 to 22 are substantially the same as the volume-average particle sizes of the aqueous pigment dispersions for ink jet recording according to Comparative Examples 7 and 9.

However, the number of coarse particles before centrifugation was smaller in the aqueous pigment dispersions for ink jet recording according to Examples 12 to 22 than in the aqueous pigment dispersions for ink jet recording according to Comparative Examples 7 and 9. Even under the same centrifugation conditions, the number of coarse particles after centrifugation was reduced more in Examples 12 to 22 than in Comparative Examples 7 and 9.

Among the examples, the aqueous pigment dispersions for ink jet recording according to Examples 12, 13, and 19, which contained a particularly few coarse particles, were shown to have better storage stability.

The aqueous inks for ink jet recording prepared using the aqueous pigment dispersions for ink jet recording according to Examples 12 to 22 were shown to have better ejection stability than the aqueous inks for ink jet recording prepared using the aqueous pigment dispersions for ink jet recording according to Comparative Examples 6 to 9.

Comparing the aqueous pigment dispersions for ink jet recording according to Example 12 and Comparative Example 6, which were different in the type of basic compound used, the aqueous pigment dispersion for ink jet recording according to Comparative Example 6, which was prepared using diethanolamine, had a larger volume-average particle size and poorer dispersion than the aqueous pigment dispersion for ink jet recording according to Example 12, which was prepared using potassium hydroxide. Furthermore, although the number of coarse particles before centrifugation was not significantly different, the aqueous pigment dispersion for ink jet recording according to Comparative Example 6 contained much more coarse particles after centrifugation and had much poorer storage stability and ejection stability than the aqueous pigment dispersion for ink jet recording according to Example 12.

The aqueous pigment dispersion for ink jet recording according to Comparative Example 8, which contained a resin prepared using a maleic acid monoester having, on its side chain, an alkyl group having four carbon atoms as the (a) component, contained much more coarse particles before and after centrifugation and had very poor storage stability and ejection stability.

An aqueous pigment dispersion produced by a production method according to the present invention contains only a few coarse particles and is suitably used as an aqueous pigment dispersion for the preparation of an ink jet recording ink.

1. A method for producing an aqueous pigment dispersion for ink jet recording, comprising:
a kneading process for kneading a mixture of a pigment, a resin having an anionic group, and an alkali metal hydroxide to produce a pigment dispersion having a solid content of 50% by mass or more, and
a mixing process for mixing and agitating the pigment dispersion in an aqueous medium,
wherein the resin having an anionic group is produced by copolymerization of a composition that contains
(a) a monomer having the following general formula (1) 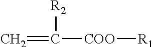
(wherein R₁ denotes a linear or branched alkyl group having 8 to 20 carbon atoms, and R₂ denotes a hydrogen atom or a methyl group)
or the following general formula (2),
HOOC—HC═CH—COO—R₃ (2)
(wherein R₃ denotes a linear or branched alkyl group having 8 to 20 carbon atoms)
(b) a styrene monomer, and
(c) a monomer having an α,β-ethylenically unsaturated bond and an anionic group,
when the (a) component is a monomer having the general formula (2), the (c) component is a monomer not having the general formula (2),
the (a) component constitutes 5% by mass or more, and the (b) component constitutes 30% by mass or more, of the total amount of all the monomers of the composition, and
the resin has an acid value in the range of 50 to 300 mgKOH/g and a mass-average molecular weight in the range of 5000 to 30000.

2. The method for producing an aqueous pigment dispersion for ink jet recording according to claim 1, wherein the mixture in the kneading process is prepared by mixing the alkali metal hydroxide, the resin having an anionic group, and the other component(s) in one batch.

3. The method for producing an aqueous pigment dispersion for ink jet recording according to claim 1, wherein the mixture in the kneading process and the pigment dispersion produced in the kneading process have a solid content in the range of 50% to 80% by mass.

4. The method for producing an aqueous pigment dispersion for ink jet recording according to claim 1, wherein the mass ratio of the resin having an anionic group to the pigment in the pigment dispersion is in the range of 1/10 to 2/1.

5. An aqueous ink for ink jet recording, comprising an aqueous pigment dispersion for ink jet recording produced by a method for producing an aqueous pigment dispersion for ink jet recording according to claim 1.
